(19) United States
(12) Patent Application Publication
(10) Pub. No.: US 2003/0117443 A1
(43) Pub. Date: Jun. 26, 2003

(54) Network based business diagnostic and credit evaluation method and system

(75) Inventors: Joseph Langner, Danville, CA (US); Douglas Labahn, Newport Beach, CA (US)

Correspondence Address: Paul D. Greeley, Esq., Ohlandt, Greeley, Ruggiero & Perle, L.L.P., One Landmark Square, 10th Floor, Stamford, CT, 06901-2682, US

(73) Assignee: Dun & Bradstreet, Inc.

(21) Appl. No.: 10/032,153

(22) Filed: Dec. 21, 2001

(51) Int. Cl. G09G 5/00

(52) U.S. Cl. 345/810

(57) ABSTRACT

A method and system that permits a user to select online one of a plurality of business services and to receive a report of that service for a target business. The method can be completely performed via a computer system associated with a database that contains business data concerning a multitude of businesses. Alternatively, the method may be performed in part by an application program running on the user's device. The user is presented with one or more menus to select a business service and to identify a target business. The method prepares a report concerning the target business based on the selected business service. The business services include, for example, prospecting, credit reports, collections help, business risk evaluations, alerts and benchmarking. The report is delivered to the user via the menus, email, postal service, courier or other.

### FIELD OF THE INVENTION

This invention relates to a method and system that offers a suite of business service products that are affordable to small businesses.

### BACKGROUND OF THE INVENTION

The small business market currently consists of more than 10 million businesses. These businesses have a need to find business associates, such as, vendors, customers, partners and others, and to evaluate business risk, collect delinquent payments, monitor key accounts and analyze the business associates, competitors or themselves vis-à-vis industry peers. To date, services that provide these needs, though available to large businesses, have been too expensive for small businesses.

Thus, there is a need for the supply of business services that are inexpensive enough for small businesses.

### SUMMARY OF THE INVENTION

The method and system of the present invention permit a user to select a business service and receive reports or other data of the business service on line. The method of the invention presents one or more menus that permit the user to select one or more of a plurality of business services and to identify a target business. Data or reports of the selected business service with respect to the target business is then prepared and delivered to the user. The reports can be delivered to the user via email or posting to the menus.

According to one embodiment of the method of the invention, the user is presented with one or more menus that permit the user to select one or more of a plurality of business services. A business service selected by the user is identified. A target business selected by the user is also identified. A report is prepared on the target business based upon the selected business service. The report is then delivered to the user.

According to one aspect of the method, the plurality of business services includes marketing, credit, collection, alert and supplier. According to another aspect of the method, the menus are presented to the user on one or more web pages. The web pages may be presented to the user directly via a browser running on a user device operated by the user. According to another aspect of the method, the plurality of business services is presented on a single menu or on separate menus, individually or in combinations.

According to another aspect of the method, the method step that presents menus to the user for selection of a business service and a target business may be implemented in whole or in part in an application program that runs on the user device. According to another aspect of the method, the presenting menus step may be implemented in whole or in part in an E-Business program that runs on an E-Business device. One or more of the menus may be cached in a cache that is in or is available to the user device or the E-Business device.

According to another aspect of the method, the user is presented with a menu that permits categorizing the target business as a customer, supplier, partner, competitor, project, or the user's company. According to another aspect of the method, one of the menus presents to the user the capability of categorizing the target business as sell to, buy from, compete, get paid, and locate.

According to another aspect of the method, one of the menus provides the user with the capability to select a risk evaluation report. According to another aspect of the method, the risk evaluation report includes a risk indicator that designates either a low risk, a moderate risk or a high risk in a color coded manner. This indicator permits the user to immediately recognize a good risk or a poor risk without having to analyze a detailed credit report.

According to another aspect of the method of the invention, a payment performance record of at least one customer of a user is presented to the user. The payment performance record is communicated to a business service providing device or system. The communication of a plurality of performance records is selective.

The system of the invention includes a computer system that has a program that enables it to perform the method of the invention.

### BRIEF DESCRIPTION OF THE DRAWINGS

Other and further objects, advantages and features of the present invention will be understood by reference to the following specification in conjunction with the accompanying drawings, in which like reference characters denote like elements of structure and:

FIG. 1 is a chart that depicts a suite of business services that the method and system of the present invention provides to a business user;

FIG. 2 is a diagram of the system of the present invention;

FIG. 3 is a diagram of the computer system of the system of FIG. 2;

FIGS. 4-23 depict menus for business services; and

FIG. 24 is a flow chart of a business service program of the computer system of FIG. 3.

### DESCRIPTION OF THE PREFERRED EMBODIMENT

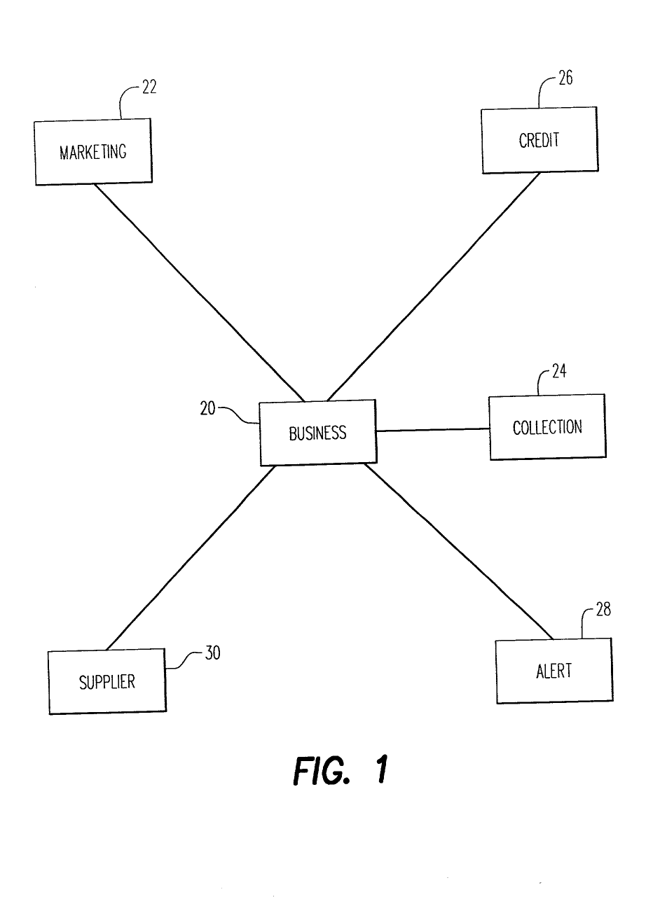

Referring to FIG. 1, a business 20 has a need to find customers, suppliers and other business partners, assess business risk, collect delinquent payments and know when changes occur that impact on suppliers, customers and peers. These needs are met by the method and system of the present invention that provides a suite of business services that include a marketing service 22, a collection service 24, a credit service 26, an alert service 28 and a supplier service 30.

The method and system of the present invention provides the suite of business services to a user via one or more menus that allow the user to select one or more of the services for a target business. For example, the target business may be a customer. The user may find the customer by using marketing service 22. The user may use credit service 26 to obtain a risk assessment or a credit report. The user may use collection service 24 for help in collecting delinquent payments. The user may use alert service 28 to receive alerts of events, such as litigation, liens and the like, that have an impact on the customer. The user may use supplier service 30 to find suppliers for business 20.

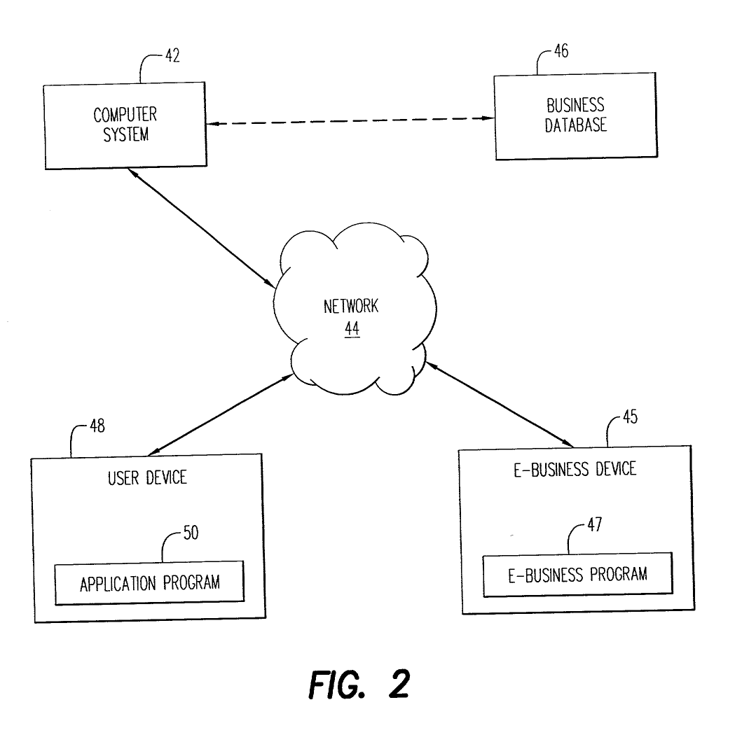

Referring to FIG. 2, a communication system 40 includes a computer system 42, a network 44, a business database 46, an E-Business device 45 and a user device 48. Network 44 interconnects computer system 42, E-Business device 45 and user device 48. Business database 46 is directly connected to computer system 42, but could be so interconnected via network 44.

Network 44 may be any wired or wireless communication network capable of conducting communications. For example, network 44 may be an Internet, an Intranet, the World Wide Web (hereinafter referred to as the “WWW” or the “Web”), the public telephone network, other networks and any combination thereof. Network communication capability, such as modems, browsers and/or server capability (not shown) is associated with each device interconnected with network 44.

User device 48 may be any suitable device upon which a browser may run, such as a personal computer, a telephone, a television set, a hand held computing device and the like. It will be appreciated by those skilled in the art that, though only one user device 48 is shown, more user devices are possible. In one embodiment of the invention, user device 48 includes an application program 50, such as a business program, in which the method and system of the invention is accessed by the user. Even parts of the method and/or system may be integrated into application program 50.

E-Business device 45 may be any suitable system with the capability of conducting interactive sessions with a user device, such as user device 48. E-Business device 45 includes an E-Business program 47 that may include a part of the method and/or system of the present invention.

Computer system 42 may be any suitable computer, presently known or developed in the future, that is capable of communicating in a protocol that is compatible with the browser capabilities of user device 48 and that is capable of running applications as described herein. Computer system 42 may be a single computer or may comprise a plurality of computers that are interconnected directly or via network 44.

Database 46 includes a data framework for data concerning a plurality of businesses with each business being identified by a business identifier (ID). For example, database 46 might include the data framework and business data of Dun and Bradstreet (D&B), the assignee of the present application. A DUNS number would then identify each business in the data framework.

Computer system 42 and business database 46 operate to provide via network 44 business data that is pertinent to the suite of business services depicted in FIG. 1 in reply to a request from user device 42 or from E-Business device 45. Business database 46 is referred to herein as a single database, by way of example, even though it may be a single database or a plurality of databases.

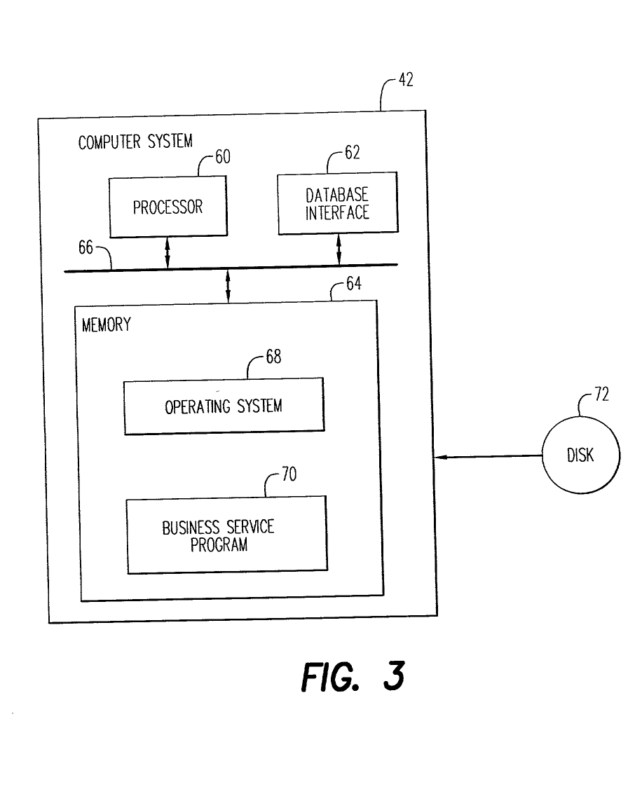

Referring to FIG. 3, computer system 42 includes a processor 60, a database interface unit 62 and a memory 64 that are interconnected via a bus 66. Memory 64 includes an operating system 68 and a business service program 70. Other programs, such as utilities, browsers and other applications, may also be stored in memory 64. All of these programs may be loaded into memory 64 from a storage medium, such as a disk 72.

Processor 60 is operable under the control of operating system 68 to run business service program 70 to respond to a request from E-Business device 45 or user device 48 to supply data pertinent to a selected business service for a target business. For example, if the selected business service is credit service 26, the user would be supplied with a risk analysis, credit report and/or other reports. The method of the invention will be initially described in the context of an online session with a user operating user device 48.

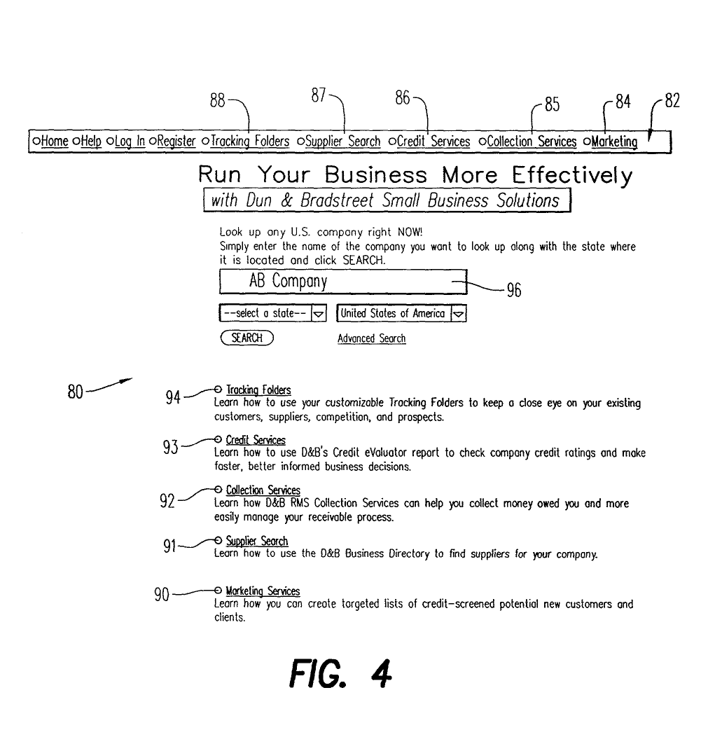

Referring to FIG. 4, the user can access computer system 42 by going to a web site associated with computer system 42. Computer system 42 under the control of business service program 70 presents a menu 80 via one or more web pages to user device 48. Menu 80 includes a task bar 82 having a marketing services button 84, a collection services button 85, a credit services button 86, a supplier search services button 87 and a tracking folders button 88. Menu 80 also includes selection buttons 90, 91, 92, 93 and 94 for marketing services, supplier search services, collection services, credit services and tracking folders, respectively.

User selection of marketing services button 84 or 90 allows the user to access other menus for marketing service 22. User selection of supplier search button 87 or 91 allows the user to access other menus for supplier service 30. User selection of collection button 85 Or 92 allows the user to access other menus for collection service 24. User selection of credit services button 86 or 92 allows the user to access other menus for credit service 26. User selection of tracking folders button 88 or 94 allows the user to access other menus for a list of the tracking folders being maintained for the user's customers, vendors, partners, competitors and others.

Menu 80 also includes an identification box 96 for entry of a target business, i.e., the business for which the business service is being requested. For the example presented herein, the target business is AB Company. If the user already has a tracking folder for AB Company, AB Company could have been alternatively selected by operating either button 88 or button 94. A list of tracking folders would then be presented to the user for selection of the target business.

It should be apparent to those skilled in the art that menu, as used herein, means any facility for presenting to a user in an online session a report, data, a selection list, selection boxes and the like. The facility may be a web page, a drop down box and/or other facilities. The selection buttons may be any suitable selectors such as boxes, buttons that are operable by a mouse click, a mouse pass over and the like.

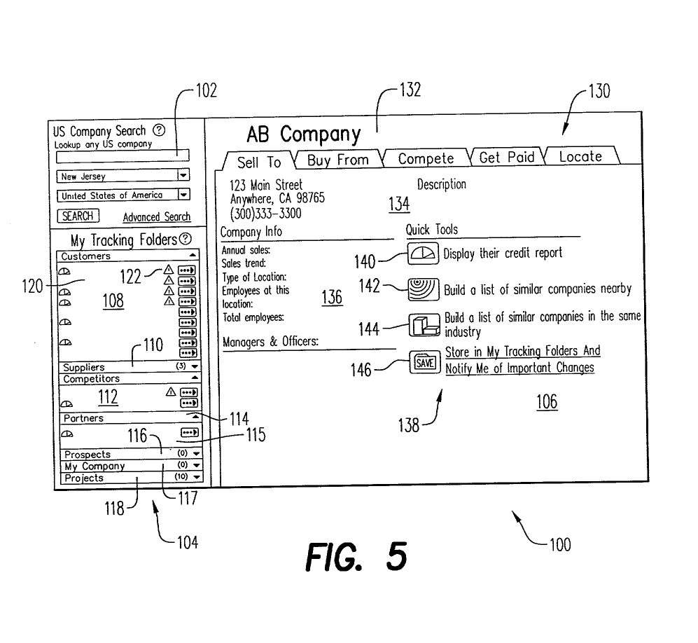

Referring to FIG. 5, a menu 100 includes a target business identification box 102, a tracking folder list 104 and a working area 106. Menu 100 could be presented to the user after menu 80 is presented or in lieu of menu 80 as an identification box 102 and/or tracking folder list 104 permit the user to identify the target business. Although not shown in FIG. 5, task bar 82 (FIG. 4) can be presented with menu 100 as well as with other menus described below to allow the user to alternatively select marketing service 22, collection service 24, credit service 26 or supplier service 30.

Tracking folder list 104 includes areas 108, 110, 112, 114, 115, 116, 117 and 118 that list folders for customers, suppliers, competitors, partners, prospects, my company (user's company) and projects, respectively. By clicking on a folder of tracking folder list 104, the user can identify the business of that folder as the target business. Each folder listing includes space for a business name, an identifier is a credit evaluator has been ordered or stored, an alert button and a more button. For example, customer area 108 includes a business name space 120, an alert button 122 and a more button 124. The presence of an alert button indicates that the user has subscribed to an alert service as described below. Selection of alert button 122 will result in the presentation or delivery of alert data for the business identified in business name area 120 to the user. Selection of more button 124 produces more detail about the business, such as prior reports from one or more of the business services, other menus to select new reports or data and the like.

Working area 106 includes a tab selector 130, a target business name area 132, an address and product description area 134, a target business data area 136 and a business service selection area 138. Tab selector area includes tabs for sell to, buy from, compete, get paid and locate. For example, if the user intends to sell to AB Company, the sell to tab is selected. If the user intends to buy from AB Company, the buy from tab is selected. In the example of FIG. 5, the sell to tab has been selected, signifying that AB Company is a customer.

Target business data area 136 may include, for example, key information, such as, annual sales, sales trend, type of location, employees at this location, total employees, names and phone numbers of key officers. Business service selection area 138 includes buttons 140, 142, 144 and 146 for selection of a credit report, a list of similar companies nearby, a list of similar companies in the same industry, or alert service 28. Selection of button 140 selects credit service 26 and results in a credit report being presented to the user. Selection of button 142 selects marketing service 22 and results in the building of a list of similar companies nearby the target business. Selection of button 144 also selects marketing service 22 and results in the building of a list of similar companies in the industry of the target company. Selection of button 146 selects alert service 28 and results in the target business being placed on alert service 28.

In one embodiment of the present invention, menus 80 and/or 100 are presented in one or more web pages to user device 48 directly from a web site associated with computer system 42. In an alternate embodiment, either menu 80, menu 100 or both is presented to the user as part of application program 50 running on user device 48. In this embodiment, menus 80 and/or 100 can be presented in whole or in part to the user to enable the user to select a target business and/or one or more business services, such as marketing service 22, collection service 24, credit service 26, alert service 28 and supplier service 30. For example, these business services or individual items (e.g., a credit report) thereof can be presented to the user as a group on a single menu, individually on separate menus or in various combinations on separate menus. Menu 80 can be presented either via hot linking to a web site or from a cache available to or as a part of user device 48.

In another alternate embodiment, either menu 80, menu 100 or both is presented to the user as part of E-Business program 47 running on E-Business device 48. In this embodiment, menus 80 and/or 100 can be presented in whole or in part to the user to enable the user to select a target business and/or one or more business services, such as marketing service 22, collection service 24, credit service 26, alert service 28 and supplier service 30. For example, these business services or individual items (e.g., a credit report) thereof can be presented to the user as a group on a single menu, individually on separate menus or in various combinations on separate menus. Menu 80 can be presented either via hot linking to a web site or from a cache available to or as a part of E-Business device 47 or user device 48.

In the alternate embodiments, activities of the user that require data or reports from computer system 42 and/or database 46 are communicated to computer system 42 via activation of buttons on the menus, email, or other communicating schemes.

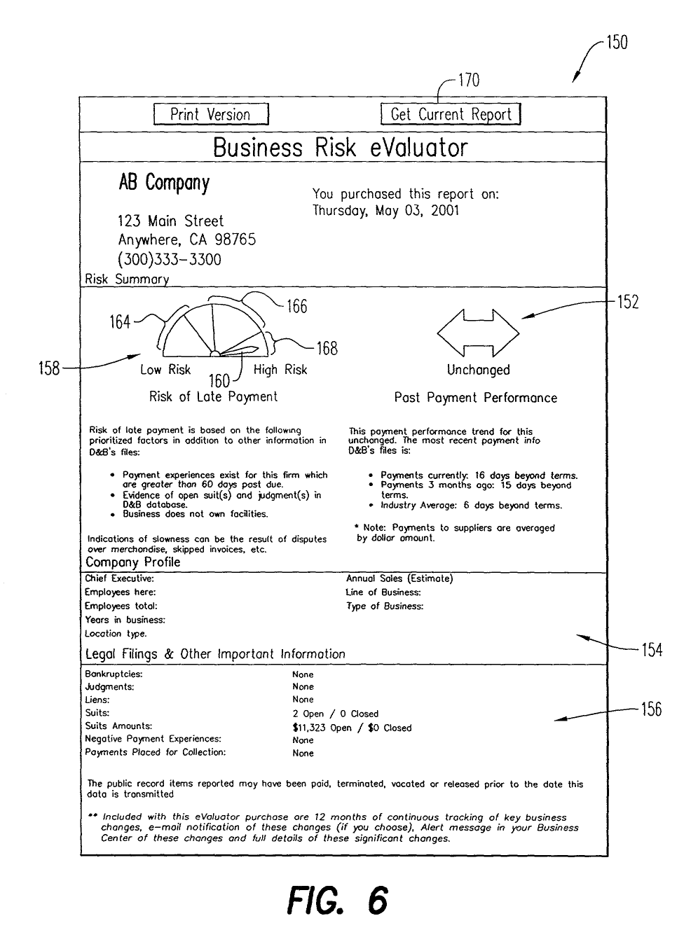

Referring to FIG. 6, a menu 150 depicts a business risk evaluation for the target business. Menu 150 includes a risk summary 152, a company profile 154 and a summary 156 of legal filings and other important information. Risk summary 152 includes a risk indicator 158 that has an indicator 160, a color coded risk scale 162 that has a zone 164 of a first color for low risk, a zone 166 of a second color for moderate risk and a zone 168 of a third color for high risk. Zone indicator 158 allows the user to immediately see if indicator 160 is in low risk zone 164, moderate risk zone 166 or high risk zone 168. This permits the user to make a rapid risk judgement without reading and analyzing all of the payment performance data of a detailed credit report. To obtain a more current credit report, the user selects a get current report button 170.

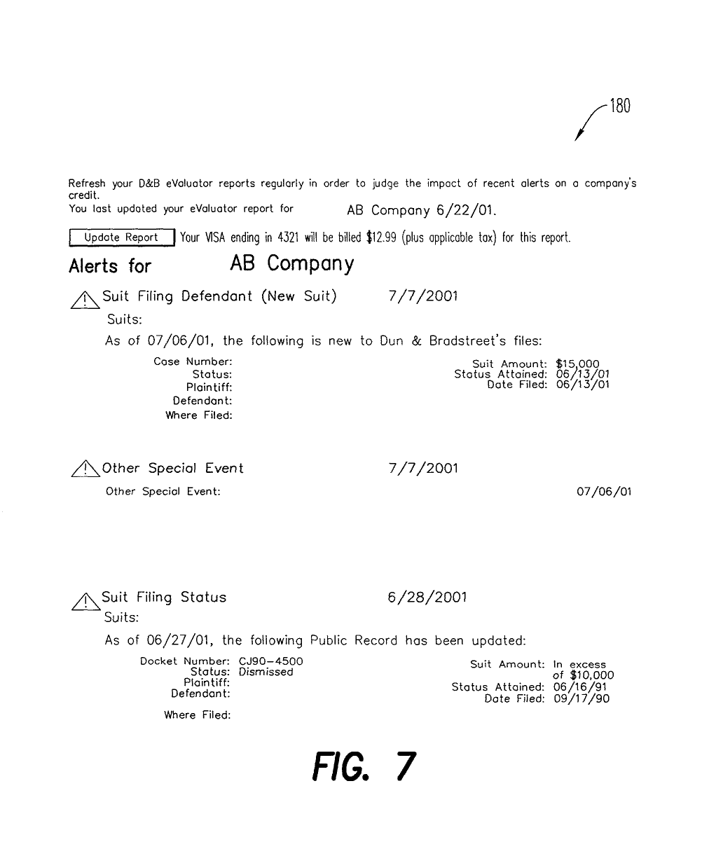

Referring to FIG. 7, a menu 180 depicts a notice of alerts for the target business (AB Company). Menu 180 is presented to the user upon selection of an alert button, such as button 122 in FIG. 4. Menu 180 includes alerts for legal filings and their status as well as alerts for other matters that have an impact on the customer whether negative or positive such as new product opportunities that might involve opportunities for the user to increase sales to the target business.

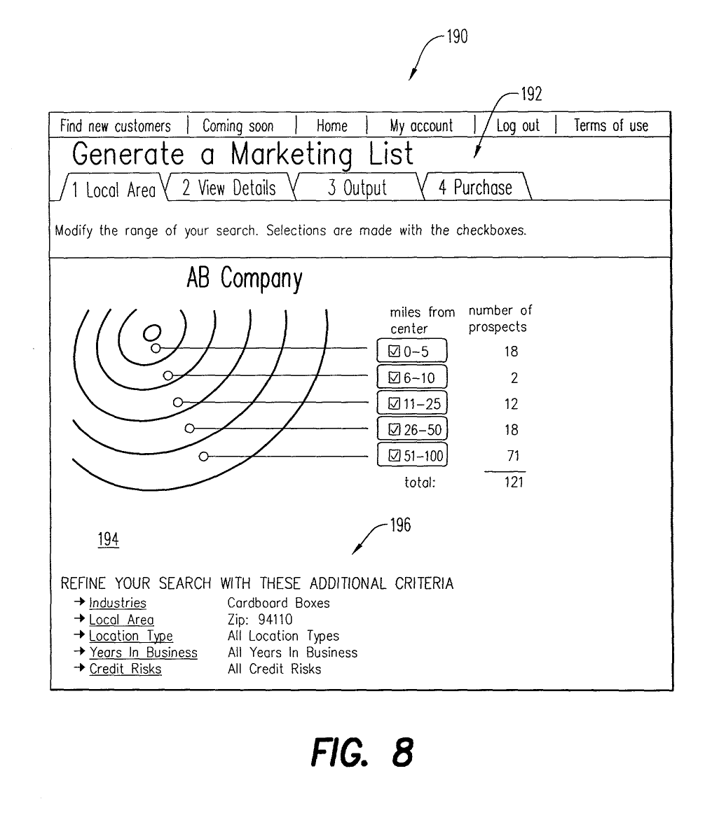

Referring to FIG. 8, a menu 190 is presented when prospecting service 22 is selected via button 142, for example, of menu 100 in FIG. 5 is selected. Menu 190 includes a tab selector 192 and a build a list by radii area 194 from the location of AB Company. Tab selector 192 includes a local area tab, a view details tab, an output tab and a purchase tab. In FIG. 8, local area tab is selected. The list is tabulated numerically by radii zones. Thus, if the user selects the radii zone of 0-5 miles, the number of similar companies is 18. If all of the zones are selected, the total number of similar companies is 121. Menu 190 includes a filter 196 that has a number of search filters, namely by industry, local area, location type, years in business and credit risks. Other filters are possible.

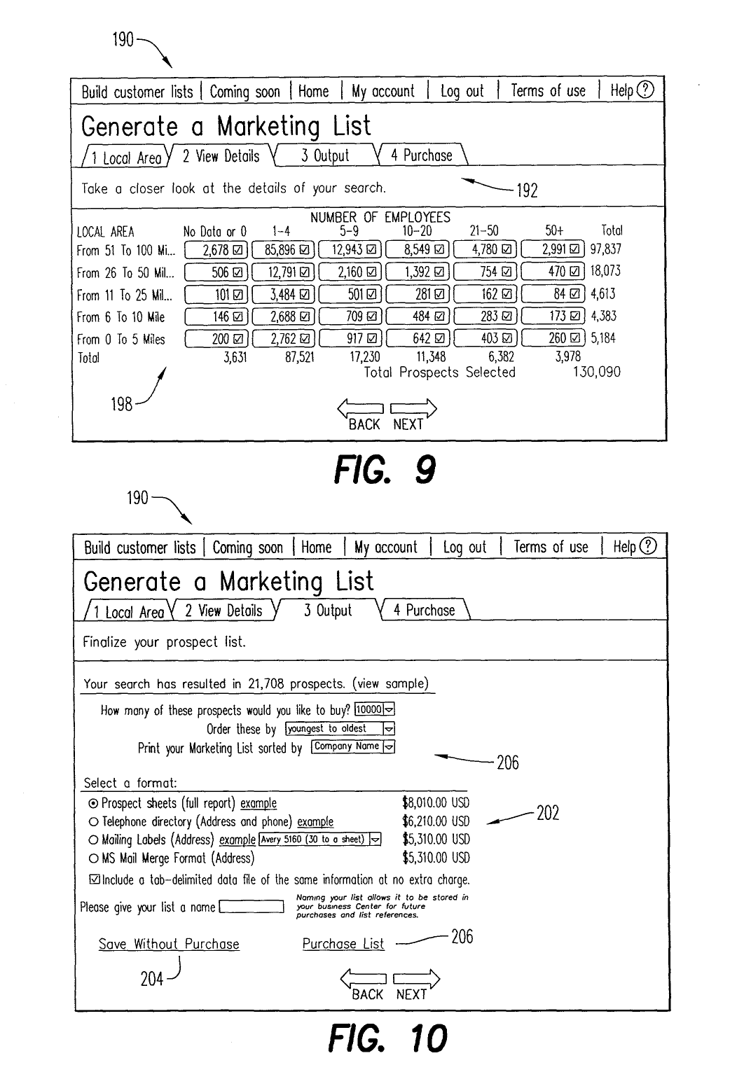

Referring to FIG. 9, the view details tab of tab selector 192 of menu 190 is selected. Menu 190 now presents a chart 198 depicting the number of employees for the prospects within the radii zones of FIG. 8. Referring to FIG. 10, the output tab of tab selector 192 of menu 190 is selected. Menu 190 now presents an area 200 for the selection of the number of prospects for the list to be purchased, a ranking and a sorting order. Menu 190 also presents a format selection area 202 for selecting a number of items, such as prospect sheets, telephone directory, mailing labels, and MS Mail merge format address. Other items are possible. The user can save without purchase by selecting a button 204 or with purchase by selecting button 206.

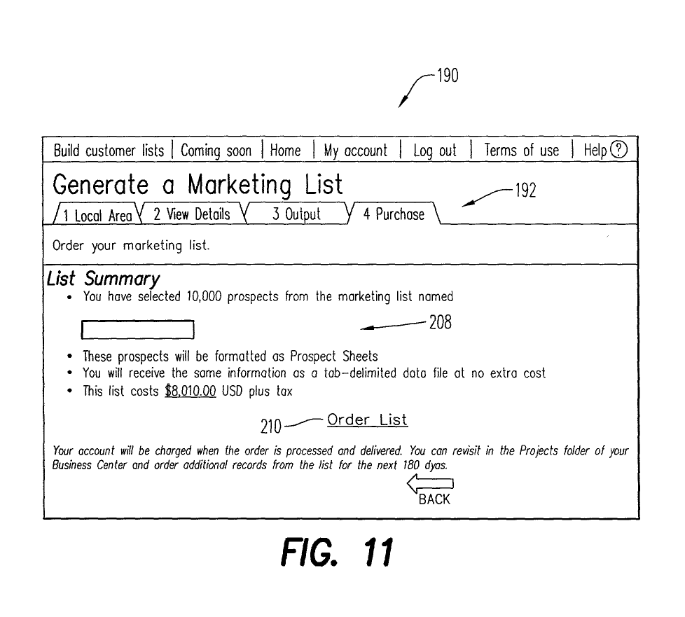

Referring to FIG. 11, the purchase tab of tab selector 192 of menu 190 is selected. Menu 190 now presents a list summary 208 of the user's purchase selections. The user can order the purchase selections by clicking on an order list button 210.

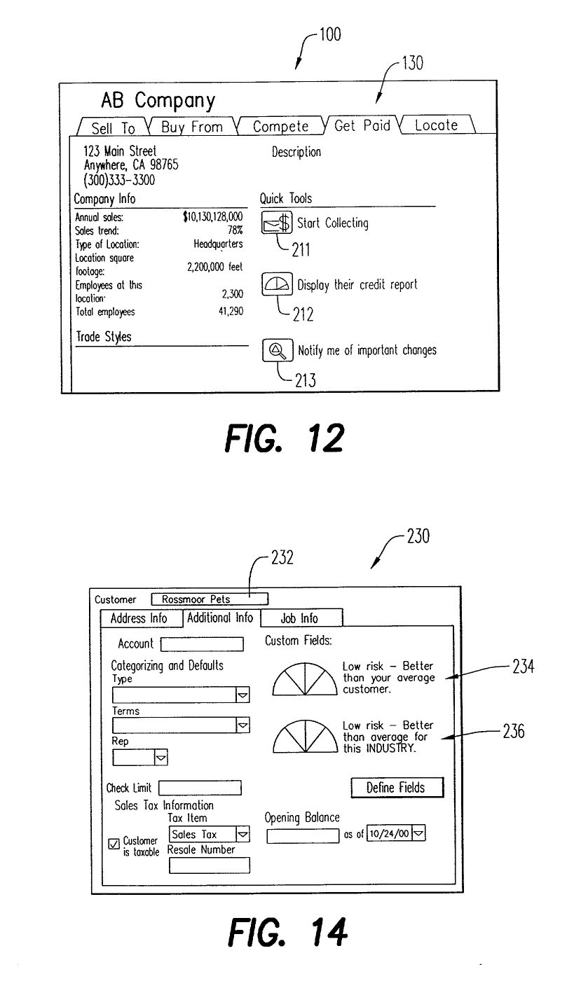

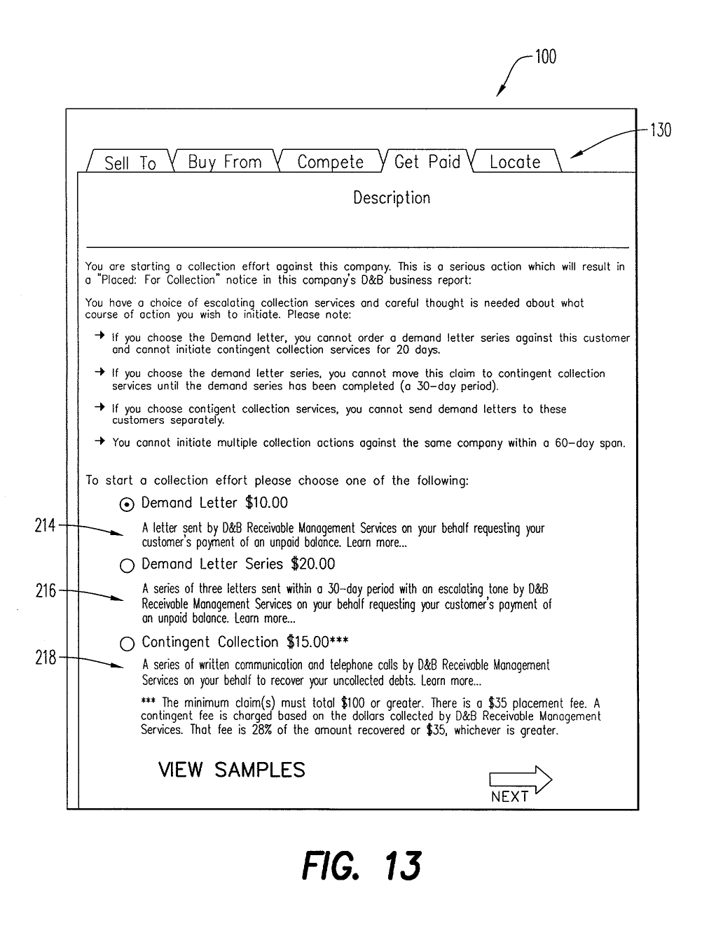

Referring to FIGS. 12 and 13, menu 100 is shown with the get paid tab of task bar 130 selected. In FIG. 12, menu 110 presents the user with the ability to start collections, display a credit report or initiating alert service 28 by choosing buttons 211, 212, and 213, respectively. If start collecting button 211 is selected, FIG. 13 shows that menu 100 presents the user the capability of choosing among a plurality of collection services. To this end, the user is presented with a single demand letter service 214, a demand letter series and a contingent collection effort.

Referring to FIG. 14, a menu 230 gives the user an instant risk assessment of a target business. Menu 230 has a target business box 232 and risk indicators 234 and 236. By making either indicators 234 or 236 or their accompanying test hot, clicking thereon can result in a credit report being presented to the user. Menu 230 can be utilized either in application program 50 of user device 48, E-Business program 47 of E-Business device 45 or by business service program 70 of computer system 42.

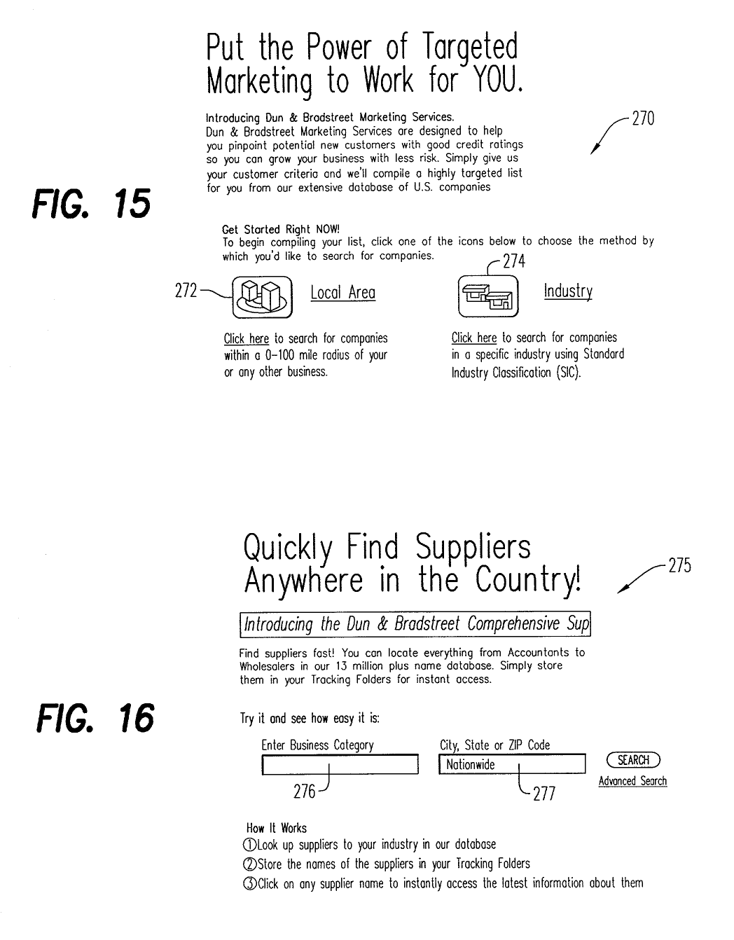

Referring to FIG. 15, a menu 270 can be used to present the user the opportunity to select a marketing list by of potential customers by local area or by industry. To this end, menu 270 includes a local area button 272 and an industry button 274. For example, operation of local area button can lead to presentation of menus that contain the radius selection presentation of menu 190 of FIG. 8.

Referring to FIG. 16, a menu 278 can be used to present the user the opportunity to find a supplier by searching for a target company by entering the target company's name and location in boxes 280 and 282. Also, tracking folder list 104 (FIG. 5) can be presented with menu 278 for the user to alternatively select the target company therefrom.

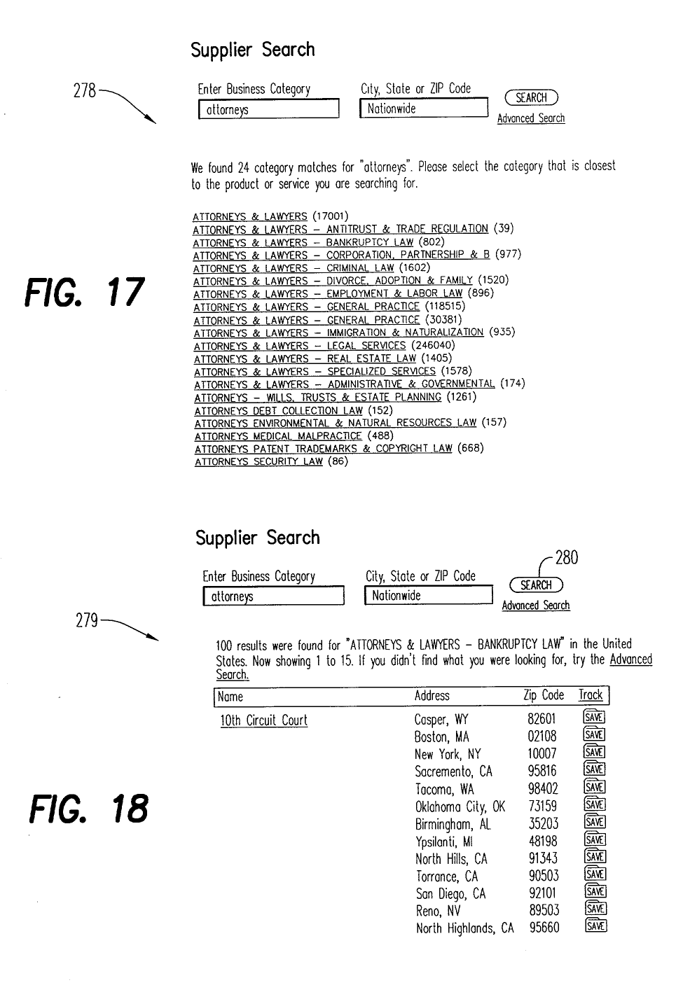

An example of a search that begins with menu 275 starts with an entry of attorneys in business category box 276. Referring to FIG. 17, a menu 278 is presented with a list of attorney categories with a prompt for the user to select a category. If the user clicks on the category of Bankruptcy Law, a menu 279, shown in FIG. 18, is presented. Menu 279depicts a list of names, cities and zip codes of bankruptcy attorneys, the actual names of the attorneys have been omitted from menu 279. If the results are not what the user wants, an advanced search button 280 can be selected.

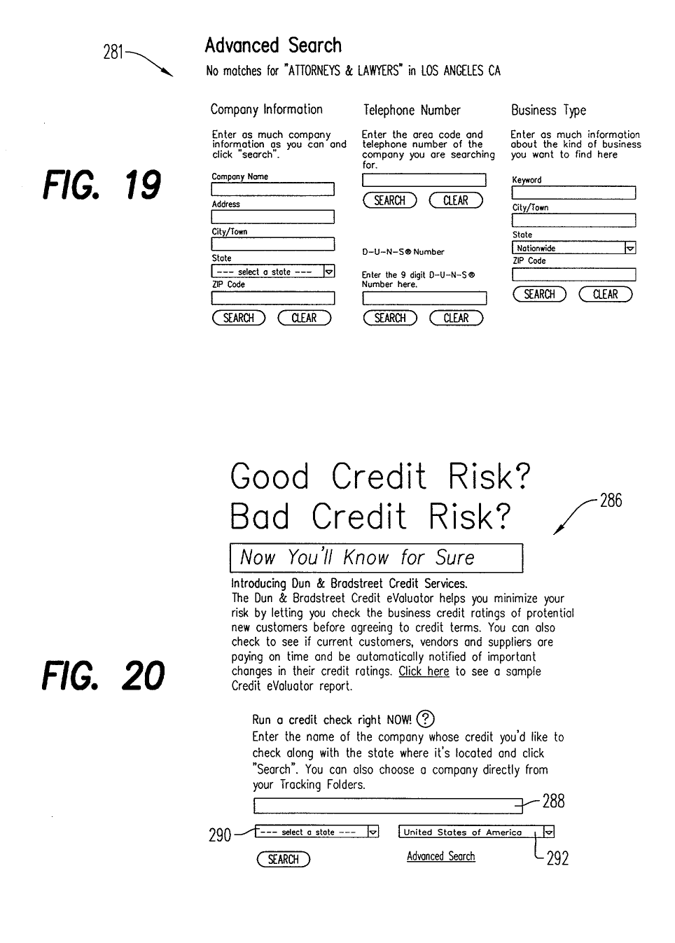

Referring to FIG. 19, a menu 281 for an advanced search includes areas for entry of company information, telephone numbers, business type and DUNS number.

Referring to FIG. 20, a menu 286 can be used to present the user the opportunity to obtain a credit report and/or rating of a target company by entering the target company's name and location in boxes 288, 290 and 292. Also, tracking folder list 104 (FIG. 5) can be presented with menu 286 for the user to alternatively select the target company therefrom.

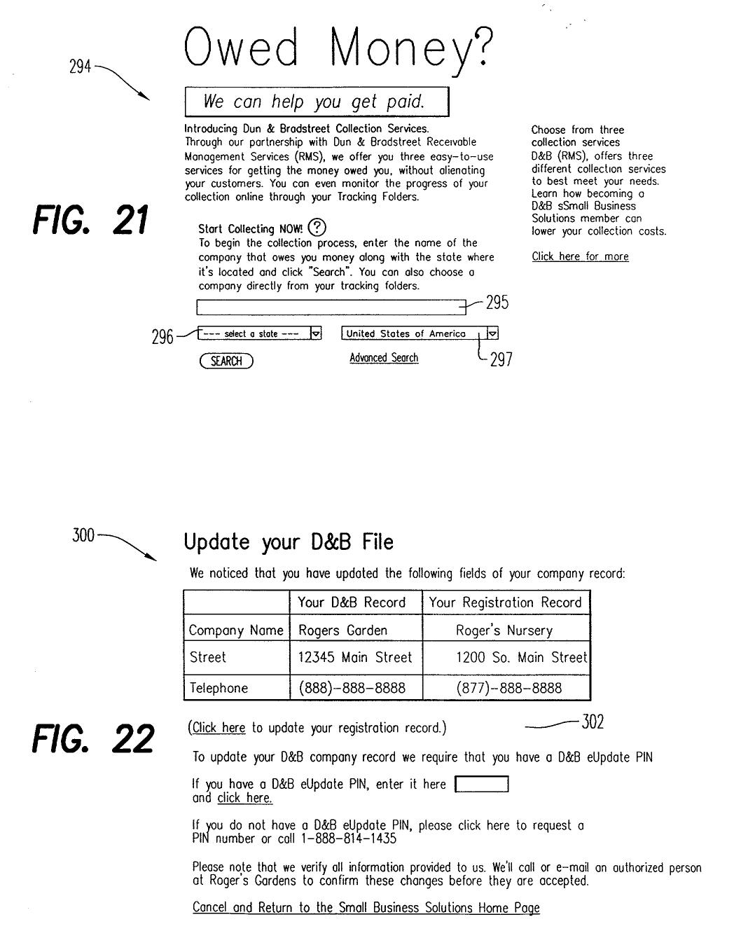

Referring to FIG. 21, a menu 294 can be used to present the user the opportunity to obtain help in collecting money owed by entering a target company and its location in boxes 295, 296 and 297. Also, tracking folder list 104 (FIG. 5) can be presented with menu 294 for the user to alternatively select the target company therefrom.

Referring to FIG. 22, a menu 300 can be presented to the user to obtain update information for the user's business record in business database 46 (FIG. 2). By clicking on the location 302, the user's business record will be presented for updating. When the updating is completed, the user can deliver the updated record to computer system 42 by email or by interactive session.

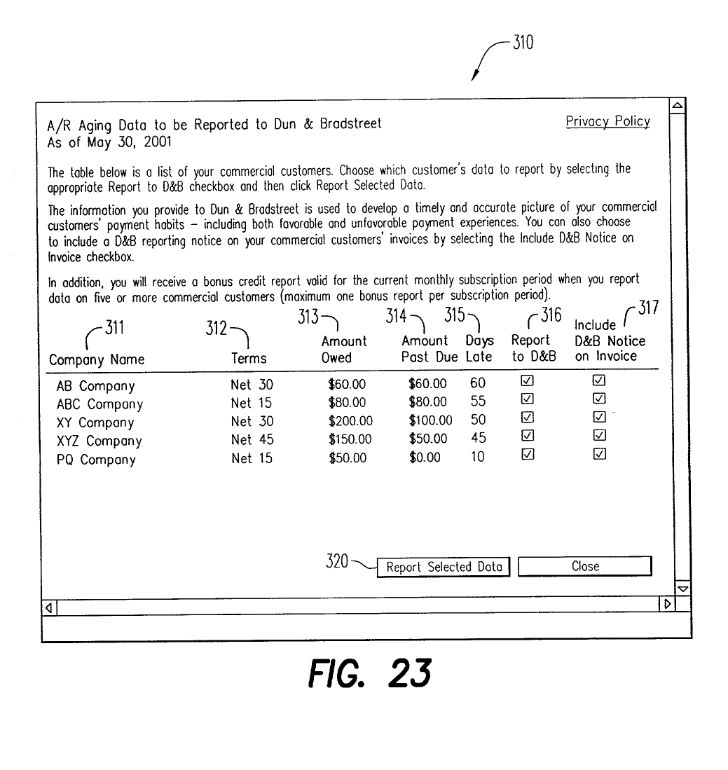

Referring to FIG. 23, a menu 310 can be presented to a user for the purpose of gathering data concerning the payment performance of the user's customers. This data, for example, is resident either in user device 48 or E-Business device 45. Menu 310 can be presented to the user either by business service program 70 running on computer system 42 or E-Business program 47 running on E-Business device 45. The payment performance data is useful to update credit data of the user's customers in business database 46.

Menu 310 includes a table that has columns 311-317 for company name, terms, amount owed, amount past due, days late, report to D&B and Include D&B notice on Invoice, respectively. Column 311 can be filled with company names extracted from the user's customer tracking folders. The data for columns 312-315 can be extracted from business application programs and the memory of user device 38. Each row represents a payment performance record for the company listed in column 311. By way of example, menu 310 can be a part of such business application program resident in user device 48, E-Business program 47 or business service program 70. Alternatively, menu 310 can be cached and controlled for presentation by any of the foregoing programs.

The user can choose which customers to report by selecting the appropriate check boxes in column 316 and then clicking on a report selected data button 320. This causes the selected payment performance records to be communicated to computer system 42 directly or indirectly via E-Business device 45. The user can choose not to report any of the customers by not selecting any check box in column 316 and clicking on a close button 322.

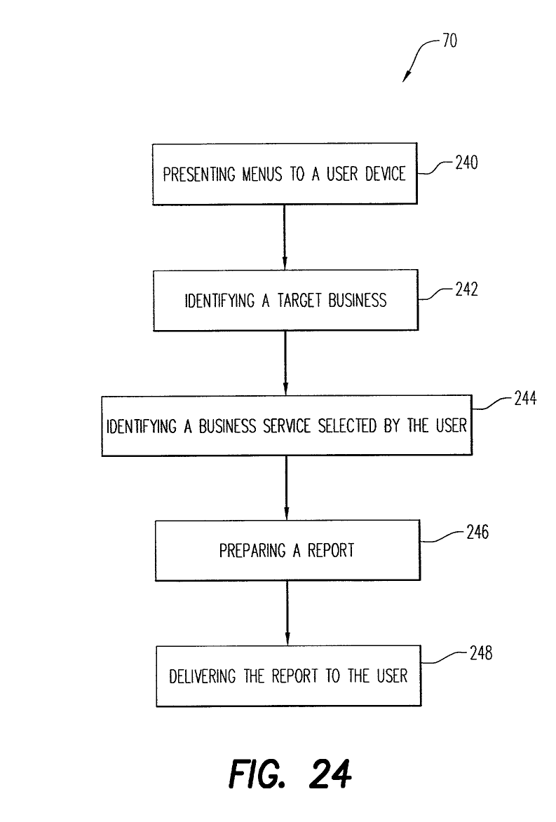

Referring to FIG. 24, business service program 70 begins at step 240 by presenting menus to user device 48. These menus include menus 80, 100, 150, 180, 190, 230, 270, 278, 286, 294, 300, 310 and other menus. Step 242 identifies a business service that is selected by the user from menu 80, for example. Step 244 identifies a target business identified by the user via menu 80, for example. Step 246 prepares any report needed by the selected business service for the identified target business. Step 248 delivers the report to the user. Step 248 may deliver the report by a menu presented on line, by email, facsimile, postal service, courier or other delivery facility.

It will be apparent to those skilled in the art that steps 240 and/or 242 can be performed in whole or in part by application program 50 in user device 48. In such case, menu 80 or other similar menu of menus can be cached in a cache available to user device 48 or could be accessed directly from computer system 42.

The present invention having been thus described with particular reference to the preferred forms thereof, it will be obvious that various changes and modifications may be made therein without departing from the spirit and scope of the present invention as defined in the appended claims.

What is claimed is:

1. A method of providing a business information service to a user comprising:
(a) presenting to said user one or more menus that permit said user to select one or more of a plurality of business services and to identify a target business; and
(b) delivering to said user data of any of said plurality of business services selected by said user that concerns said target business.

2. The method of claim 1, wherein each of said plurality of business services is of the group consisting of: credit, collection, alert, marketing and supplier.

3. The method of claim 1, wherein steps (a) and (b) are conducted online with said user.

4. The method of claim 1, wherein at least one of steps (a) and (b) is at least partially implemented in an application in a user device operated by said user.

5. The method of claim 4, wherein at least one of said one or more menus is cached in said user device.

6. The method of claim 1, wherein at least one of steps (a) and (b) is at least partially implemented in an application in a business device that presents at least one of said one or more of said menus to a user device operated by said user.

7. The method of claim 6, wherein said at least one of said one or more menus is cached in said business device.

8. The method of claim 1, wherein said one or more menus are presented to said user on one or more web pages.

9. The method of claim 8, wherein step (a) presents said one or more web pages to said user directly via a browser running on a user device operated by said user.

10. The method of claim 1, wherein at least two of said plurality of business services are presented on a single menu to said user for selection.

11. The method of claim 1, further comprising (c) presenting said user with a menu that permits categorizing said target business to one of the group consisting of: customer, supplier, partner, competitor, project, and said user's company.

12. The method of claim 1, wherein a first one of said one or more menus presents to said user the capability of categorizing said target business to one of the group consisting of: sell to, buy from, compete, get paid, and locate.

13. The method of claim 1, wherein said one or more menus provide said user with the capability to select a risk evaluation report.

14. The method of claim 13, wherein said risk evaluation report includes a risk indicator that designates either a low risk, a moderate risk or a high risk in a color coded manner.

15. The method of claim 1, wherein step (b) delivers said data to said user via email or posting to said one or more menus.

16. The method of claim 1, further comprising: communicating an alert notice concerning said target business to said user.

17. The method of claim 16, wherein said alert notice is filed in a tracking folder for said target business, and wherein said tracking folder is accessible via said one or more menus.

18. The method of claim 1, further comprising: presenting to said user a payment performance record of at least one of said user's customers, and communicating said payment performance record.

19. The method of claim 18, wherein said user is presented with a payment performance record of each of a plurality of said user's customers, and wherein said payment performance records are selectively communicated.

20. A method of providing a business information service to a user comprising:
(a) presenting to said user one or more menus that permit said user to select one or more of a plurality of business services;
(b) identifying a target business selected by said user;
(c) preparing a report on said target business based upon a selected one of said plurality of business services; and
(d) delivering said report to said user.

21. The method of claim 20, wherein each of said plurality of business services is of the group consisting of: credit, collection, alert, marketing and supplier.

22. The method of claim 20, wherein steps (a), (b), (c) and (d) are conducted online with said user.

23. The method of claim 20, wherein at least one of steps (a) and (b) is at least partially implemented in an application in a user device operated by said user.

24. The method of claim 23, wherein at least one of said one or more menus is cached in said user device.

25. The method of claim 20, wherein said one or more menus are presented to said user on one or more web pages.

26. The method of claim 25, wherein step (a) presents said one or more web pages to said user directly via a browser running on a user device operated by said user.

27. The method of claim 20, wherein at least two of said plurality of business services are presented on a single menu to said user for selection.

28. The method of claim 20, further comprising (e) presenting said user with a menu that permits categorizing said target business to one of the group consisting of: customer, supplier, partner, competitor, project, and said user's company.

29. The method of claim 20, wherein a first one of said one or more menus presents to said user the capability of categorizing said target business to one of the group consisting of: sell to, buy from, compete, get paid, and locate.

30. The method of claim 20, wherein said one or more menus provide said user with the capability to select a risk evaluation report.

31. The method of claim 30, wherein said risk evaluation report includes a risk indicator that designates either a low risk, a moderate risk or a high risk in a color coded manner.

32. The method of claim 20, wherein step (d) delivers said data to said user via email or posting to said one or more menus.

33. The method of claim 20, wherein at least one of steps (a) and (b) is at least partially implemented in an application in a business device that presents at least one of said one or more of said menus to a user device operated by said user.

34. The method of claim 33, wherein said at least one of said one or more menus is cached in said business device.

35. The method of claim 20, further comprising: communicating an alert notice concerning said target business to said user.

36. The method of claim 35, wherein said alert notice is filed in a tracking folder for said target business, and wherein said tracking folder is accessible via said one or more menus.

37. The method of claim 20, further comprising: presenting to said user a payment performance record of at least one of said user's customers, and communicating said payment performance record.

38. The method of claim 37, wherein said user is presented with a payment performance record of each of a plurality of said user's customers, and wherein said payment performance records are selectively communicated.

39. A method of communicating business data among a user device and a business service provider device, said method comprising:
(a) presenting to said user a payment performance record of at least one of said user's customers; and
(b) communicating said payment performance record to said business service provider device.

40. The method of claim 39, wherein said user is presented with a payment performance record of each of a plurality of said user's customers, and wherein said payment performance records are selectively communicated.

41. The method of claim 39, wherein said payment performance record is in a format useable by said business service provider device and contains data provided at least in part from an application of said user device.

42. A computer for providing a business information service to a user comprising:
means for presenting to said user one or more menus that permit said user to select one or more of a plurality of business services;
means for identifying a target business selected by said user;
means for preparing a report on said target business based upon a selected one of said plurality of business services; and
means for delivering said report to said user.

43. A memory media for operating a computer to provide a business information service to a user comprising:
means for operating said computer to perform a first operation of presenting to said user one or more menus that permit said user to select one or more of a plurality of business services;
means for operating said computer to perform a second operation of identifying a target business selected by said user;
means for operating said computer to perform a third operation of operating said computer to perform a third operation of preparing a report on said target business based upon a selected one of said plurality of business services; and
means for operating said computer to perform a fourth operation of delivering said report to said user.
